(19) United States
(12) Patent Application Publication
(10) Pub. No.: US 2018/0261123 A1
(43) Pub. Date: Sep. 13, 2018

(54) METHOD FOR EDUCATING SPORTS FANS

(71) Applicant: Jacques Benjamin Miles, Harrisburg, PA (US)

(72) Inventor: Jacques Benjamin Miles, Harrisburg, PA (US)

(21) Appl. No.: 15/453,870

(22) Filed: Mar. 8, 2017

(51) Int. Cl. G09B 19/00; G09B 7/00; A63F 9/18

(52) U.S. Cl. CPC G09B 19/00; A63F 9/183; G09B 7/00

(57) ABSTRACT

A method for educating a sports fan is disclosed. The method includes the steps of displaying game content over a medium; showing one or more Messages; showing one or more Sports Interpretation Questions related to said Message(s); receiving and/or recording an Answer to the Sports Interpretation Question(s) in response to said Sports Interpretation Questions(s); showing one or more Trivia Questions; receiving and/or recording an Answer to the Trivia Question(s) in response to said Trivia Question, wherein (a), (b), (c), (d), (e) and (f) occur as game content is displayed; repeating steps (a), (b), (c), (d), (e) and (f) until a set number of Sports Interpretation Questions and Trivia Questions are shown; and calculating a score based on the Answers received in response to one or more Sports Interpretation Questions and Trivia Questions.

### FIELD OF THE INVENTION

The present invention relates to one or more methods for educating sports fans about the rules, history, etc. of one or more sports as well as methods for testing fans' knowledge of one or more sports.

### BACKGROUND

All sports such as football, basketball, baseball and similar at both the professional and lower levels are governed by rules and have rich traditions and histories. Sports rules comprise both a written rule and an interpretation of the rule. If sports rules were not complex enough, new rules are constantly adopted and existing rules are always being amended or interpreted differently.

Knowledge of sports rules and their interpretations are not just important for officials. The experiences of fans can be improved by an enhanced understanding of sports rules.

In addition to knowing the rules, a fan of any sport must have at least a basic knowledge of the sport's history, traditions and related. Such information about a sport grows exponentially every season so it is difficult for a fan to stay informed. But being an informed fan is an essential part of the sporting experience.

Fans wish to be able to test their knowledge about a sport. And when fans have a lot of knowledge about a sport, they want to be able to demonstrate their superior knowledge of the sport including interpretations of rules, the history of a sport, key sports facts and figures, etc.

A fun and innovative method for improving fans' knowledge of a sport including knowledge of the sport's rules, key sports facts, the history of the sport, etc. is sorely needed. The present invention provides such a method. The present invention, in addition to providing a method for educating fans, provides a method for testing fans' knowledge of a sport as well.

### SUMMARY OF THE INVENTION

In a non-limiting embodiment, the present invention is a method for educating sports fans about a sport comprising:
(a) displaying game content over a medium;
(b) showing one or more Messages;
(c) showing one or more Sports Interpretation Questions related to said Message(s);
(d) receiving and/or recording an Answer to the Sports Interpretation Question(s) in response to said Sports Interpretation Questions(s);
(e) showing one or more Trivia Questions;
(f) receiving and/or recording an Answer to the Trivia Question(s) in response to said Trivia Question(s),
   Wherein (a), (b), (c), (d), (e) and (f) occur as game content is displayed;
(g) repeating steps (a), (b), (c), (d), (e) and (f) until a set number of Sports Interpretation Questions and Trivia Questions are shown; and
(h) calculating a score based on the Answers received in response to one or more Sports Interpretation Questions and Trivia Questions.

In a non-limiting embodiment, the present invention is a method for testing the knowledge of sports fans comprising:
(a) displaying game content over a medium;
(b) showing one or more Messages;
(c) showing one or more Sports Interpretation Questions related to said Message(s);
(d) receiving and/or recording an Answer to the Sports Interpretation Question(s) in response to said Sports Interpretation Question(s);
(e) showing one or more Trivia Questions;
(f) receiving and/or recording an Answer to the Trivia Question(s) in response to said Trivia Question,
   Wherein (a), (b), (c), (d), (e) and (f) occur as game content is displayed;
(g) repeating steps (a), (b), (c), (d), (e) and (f) until a set number of Sports Interpretation Questions and Trivia Questions are shown; and
(h) calculating a score based on the Answers received in response to one or more Sports Interpretation Questions and Trivia Questions.

### DESCRIPTION OF THE INVENTION

The present invention is a method for educating sports fans about a sport comprising
(a) displaying game content over a medium;
(b) showing one or more Messages;
(c) showing one or more Sports Interpretation Questions related to said Message(s);
(d) receiving and/or recording an Answer to the Sports Interpretation Question(s) in response to said Sports Interpretation Question(s);
(c) showing one or mo re Trivia Questions;
(d) receiving and/or recording an Answer to the Trivia Question(s) in response to said Trivia Question(s),
   Wherein (a), (b), (c), (d), (e) and (f) occur as game content is displayed;
(g) repeating steps (a), (b), (c), (d), (e) and (f) until a set number of Sports Interpretation Questions and Trivia Questions are shown; and
(h) calculating a score based on the Answers received in response to one or more Sports Interpretation Questions and Trivia Questions.

According to the present invention, game content is displayed on one or more mediums. The medium can be a visual medium such as a screen (i.e., computer screen, television screen, etc.); an audible medium such as loudspeakers; a combination of visual medium and an audible medium; etc.

The game content comprises multiple plays and/or sequences of events from one or more sporting contests as well as other video content and/or one or more photos. The other video content and photos can be sports related and/or not related to sports. The video content and photos can be historic locations in a city, popular non-sports figures, etc.

The game content can also include, in addition to the video content, audio content including music, voices and other sounds.

In a non-limiting embodiment, the game content comprises multiple video clips from previously played games.

The game content can comprise either live sports action or recorded sports action. The game content can be from a variety of sports including, but not limited to, football, basketball, soccer, baseball, hockey, cricket and rugby. The game content can be from any level of sport including youth league, high school, college, professional, etc.

In a non-limiting embodiment, the game content comprises or consists of live action from a game/sporting contest being played in the moment or with a slight delay relative to the display of the game content.

In a non-limiting embodiment, the game content comprises or consists of recorded content from a previously played game(s)/sporting contest. The game content can comprise multiple plays and/or sequences of events and/or video clips from one or more previously recorded sporting contests/games. The recorded game content can be edited before it is displayed.

In a non-limiting embodiment, when recorded game content is displayed, the various plays and/or sequences of events and/or video clips can run in a semi-continuous or continuous manner. This provides a User experience similar to a live game in terms of look and feel.

In a non-limiting embodiment of the invention, the game content is edited in a manner which reduces or eliminates evidence of certain events which took place during the game. For example, certain events which might be edited out include actions of officials such as the throwing of a flag, the blowing of a whistle, the enforcement of a penalty, etc.

In another non-limiting embodiment of the invention, the game content is edited in a manner that enhances the video. For example, one or more sections of the game content can be digitally enhanced to sharpen the audio/video of the game content or increase the scale of objects in the game content (i.e., make objects in the game content appear larger and/or make images more well-defined).

In a non-limiting embodiment, the displayed game content can be from one or more vantage points/viewing angles. The display of game content is not restricted to the view from any particular angle or vantage point.

Game content can also comprise video and/or audio associated with a person, a place, a team, an object, etc. For example, the game content can be video showing one or more persons. As another example, the game content can be audio of a person speaking and/and/or audio of sounds or other. As yet another example, the game content can be video and/or photos of a team or a stadium or a landmark or a piece of equipment or almost anything. Also, the displayed game content can include a combination of video and audio.

According to the present invention, the method comprises showing a Message. As game content is displayed, the system shows a Message. The Message can be related to an upcoming portion of the game content or game content which will be displayed during and/or after the message is shown.

According to the present invention, the system can both generate/display various information and receive as well as record various information.

Typically, the Message provides a description of a forthcoming event to be shown in the displayed game content. For example, the Message can provide a possible description of one or more of the following in game content which will be displayed: a penalty/foul/infraction, a scoring play and/or other subjective, sports specific decision in response to displayed game content.

As the game content is displayed, if more than one Message is displayed, the various Messages are identified as a first Message, a second Message, a third Message and so on and so on.

According to the present invention, the method comprises showing a Sports Interpretation Question which is related to a previously shown Message. As game content is displayed, a Sports Interpretation Question which request certain input from a User. The Sports Interpretation Question can also be related to game content which was displayed/shown. A Sports Interpretation Question can be displayed/shown on a screen and/or announced via audible means.

A Sports Interpretation Question typically relates to a potential rules infraction/penalty/foul (includes the penalty, the enforcement of the penalty and related), a decision regarding a scoring play and/or other subjective, sports specific decisions which must be made during the course of a game.

After a Sports Interpretation Question is shown, information (“Replay Information”) may be received which triggers one or more replays of a certain portion(s) or previously displayed game content to be shown again.

In a non-limiting embodiment of the invention, two or five or ten or twenty or more Sports Interpretation Questions are shown as the game content is displayed. There is no limit on the number of Sports Interpretation Questions which can be shown. Any number of Sports Interpretation Questions is suitable.

According to the present invention, the method comprises receiving and recording an Answer to the Sports Interpretation Question in response to a Sports Interpretation Question.

Depending on the Answer to the Sports Interpretation Question received in response to a Sports Interpretation Question, one or more Follow Up Sports Interpretation Questions can be shown.

In a non-limiting embodiment of the invention, various types of Comments entered by a User can be received by the System. For example, a Comment(s) (an “Initial Reaction Comment(s)”) associated with an Answer to a Sports Interpretation Question can be received by the System. The Initial Reaction Comment(s) can also be displayed by the System. A First Initial Reaction Comment(s) can be associated with a First Answer to a First Sports Interpretation Question, and Second Initial Reaction Comment(s) can be associated with a Second Answer to a First Sports Interpretation Question and so on and so on. The Comments enable Users to go more in depth and have a discussion/conversation with other Users.

In a non-limiting embodiment of the invention, a Comment(s) from one or more Users who previously used the System (not the current User) can be displayed/shown by the System. This type of Comment(s) is referred to as a Previous User Comment(s).

According to the present invention, a First Sports Interpretation Question can be associated with a First Answer to the First Sports Interpretation Question and a First Follow Up Sports Interpretation Question; a Second Sports Interpretation Question can be associated with a Second Answer to the Second Sports Interpretation Question and a Second Follow Up Sports Interpretation Questions; and so on and so on.

The exact nature of the Sports Interpretation Question, the Answer to the Sports Interpretation Question, and the Follow Up Sports Interpretation Questions depend on the specific sport which is the subject of the game content being displayed.

The Sports Interpretation Question, the Answer to the Sports Interpretation Question, and any Follow Up Sports Interpretation Question typically relate to a rules infraction/penalty/foul (includes the penalty, the enforcement of the penalty and related), a decision regarding a scoring play and/or other subjective, sports specific decisions which must be made during the course of a game.

According to the present invention, the method comprises showing one or more Trivia Questions. A Trivia Question can be about a sports topic. And/or a Trivia Question can cover a topic not related to sports such as landmarks of a local area, popular cultural figures, key facts and dates, etc.

In a non-limiting embodiment of the invention, two or five or ten or twenty or more Trivia Questions are shown as the game content is displayed. There is no limit on the number of Trivia Questions which can be shown. Any number of Trivia Questions is suitable.

According to the present invention, the method comprises receiving and/or recording an Answer to the Trivia Question in response to the Trivia Question.

According to the present invention, a First Trivia Question can be associated with a First Answer to the First Trivia Question; a Second Trivia Question can be associated with a Second Answer to the Second Trivia Question; and so on and so on.

According to the present invention, the Sports Interpretation Questions and the Trivia Questions can be shown in any order. As one example, two Sports Interpretation Questions can followed by two Trivia Questions. In another example, one Sports Interpretation Question can be shown followed by a Trivia Question which is then followed by a Sports Interpretation Question which is followed by a Trivia Question.

According to the present invention, the game content displayed can be limited to one specific sport. In one embodiment, the sport can be football, baseball, basketball, hockey, soccer, cricket, rugby, etc. or any other sport. The game content can be limited to a particular level of sport-professional sports, college sports, high school sports, national team sports, little league sports, etc. The game content can also focus on a particular player and/or a particular game and/or a particular event like the NCAA Final Four or the Super bowl.

Depending on the sport which is displayed in the game content, the Sports Interpretation Questions and related (i.e., Answer to the Sports Interpretation Question, and any Follow Up Sports Interpretation Question) will be different. The Sports Interpretation Questions and related will be drawn from the specific sport and be derived from a certain portion of the displayed game content.

Most often, the Sports Interpretation Questions and related typically relate to rules infractions, scoring plays, and/or other subjective, sports specific decisions which must be made during a game of a specific sport.

For football, for example, the Sports Interpretation Questions and related typically relate to (1) rules infractions such as, but not limited to, holding, clipping, grabbing a facemask, roughing the passer, offsides, false start and other infractions/violations of the rules spelled out in the official rule book for the level of play; (2) scoring plays including touchdowns, extra points and field goals; and/or (3) other subjective, sports specific decisions which must be made during football games including, but not limited to, complete/incomplete passes, fumbles, recoveries of fumbles and similar.

For soccer, for example, the Sports Interpretation Questions and related typically relate to (1) fouls including kicking an opponent, tripping, jumping into an opponent (like when you are going for a header), charging into an opponent, pushing, tackling from behind, tackling an opponent and you make contact with the player prior to making contact with the ball, holding, touching the ball with your hands (if you are not the goalkeeper), and other infractions/violations of the rules spelled out in the official rule book for the level of play; (2) scoring plays including goals; and/or (3) other subjective, sports specific decisions which must be made during soccer games including, but not limited to, giving a caution or yellow card, giving a red card, awarding an indirect free kick, awarding a direct free kick, etc.

For basketball, for example, the Sports Interpretation Questions and related typically relate to (1) rules infractions including, but not limited to, the following: double dribble, traveling violation, blocking foul, charge, goal tending, and other infractions/violations of the rules spelled out in the official rule book for the level of play; (2) scoring plays like field goals and free throws; and/or other subjective, sports specific decisions which must be made during basketball games including, but not limited to, last second shots, stepping out of bounds, fouls in the act of shooting, 2 or 3 point field goals and similar.

For hockey, for example, the Sports Interpretation Questions and related typically relate to (1) penalties including the following classes: minor/bench minor penalties, major penalties, misconduct penalties, match penalties, penalty shots and other infractions/violations of the rules spelled out in the official rule book for the level of play; (2) scoring plays including goals; and/or other subjective, sports specific decisions which must be made during hockey games and are well known in the art and in the sport of hockey.

For baseball, for example, the Sports Interpretation Questions and related typically relate to (1) infractions/violations of the rules spelled out in the official rule book for the level of play; (2) scoring plays including runs; and/or (3) other subjective, sports specific decisions which must be made during baseball games and are well known in the art and in the sport of baseball.

For cricket, for example, the Sports Interpretation Questions and related typically relate to (1) infractions/violations of the rules spelled out in the official rule book for the level of play; (2) scoring plays including runs; and/or (3) other subjective, sports specific decisions which must be made during cricket matches and are well known in the art and in the sport of cricket.

For rugby, for example, the Sports Interpretation Questions and related typically relate to (1) infractions/violations of the rules spelled out in the official rule book for the level of play; (2) scoring plays including a try, a penalty try, a converted try, a field goal, a penalty goal, etc.; and/or (3) other subjective, sports specific decisions which must be made during rugby matches and are well known in the art and in the sport of rugby.

When the system is receiving information, the display of game content can be temporarily stopped or paused. After the system receives the information, the display of game content can be resumed at an appropriate point as defined by the system or other.

According to the present invention, a score can be calculated after a predetermined number of Sports Interpretation Question and/or Trivia Questions have been shown. In a non-limiting embodiment of the invention, the corresponding Answers must be received and/or recorded before a score is calculated.

In a non-limiting embodiment, the score is generated by comparing one or more Answers to Sports Interpretation Questions and one or more Answers to Trivia Questions received by the system against a standard representing “correct answers”. The correct answers can be determined by an authoritative person as one or more professional referees for a given sport or a body such as the National Collegiate Athletic Association (NCAA), the National Football League (NFL), the National Basketball Association (NBA), the Canadian Football League (CFL), the English Premier League, etc.

In a non-limiting embodiment of the invention, the score is displayed on the screen and/or audibly conveyed.

The described invention also encompasses a method for testing and/or measuring the sports knowledge of a fan.

According to the present invention, while the game content is being displayed, received information is associated with various input signals (i.e., first input signal, second input signal, third input signal and so on and so on) received from one or more input devices. The input signals are received and transmitted using methods which are well known in the art.

The one or more input devices can be a keyboard, joystick, or other similar device as is well known in the art. In a non-limiting embodiment of the invention, an input device is a whistle or other device capable of making sound.

In the practice of the invention, the various input and output devices referred to herein can be connected using various input/output connectors and ports which are well known in the art. The various input/output devices can communicate with the personal computing device by any suitable means such as, but not limited to, a wireless system such as “Bluetooth”, cable, etc.

In the practice of the invention, an input signal can comprise one or more Answers to Sports Interpretation Questions and one or more Answers to Trivia Questions.

In practice, the method of the present invention will be implemented using a system like a personal computing device or similar. The method of the invention will performed on a personal computer or similar using one or more software programs or similar. The software program(s) can be written on a DVD or other programmable device as in known in the art so that it can be read and actuated by a personal computing device or other. The practice of this invention is not limited to any particular computing platform such as a personal computer using a Windows operating system, a Sony PSP, a Microsoft X Box, a Nintendo gameboy, a mobile device, a smart phone, etc. The present invention can be practiced on any platform.

According to the present invention, the processing (transmitting, receiving, etc.) of the various input signals/received information and output signals/displayed or shown information described above is accomplished using methods which are well known in the art.

The personal computing device utilized to practice the present invention can contain one or more video and/or graphic systems including components for receiving compressed and uncompressed graphics and video and for processing the received graphics and video into displayable format. The graphic display system can be any one capable of processing video input signals that may include analog video signals, digital video signals, etc. The analog signals can be, for example, NTSC, PAL and SECAM signals or any other conventional type of analog signal. The digital signals can be decoded MPEG signals or other format of digital video output.

Suitable methods for processing audio and video signals are well known in the art. A suitable method is described in U.S. Pat. No. 6,728,312 assigned to Forgent Networks, Inc. (Austin, Tex.).

The present invention can be used in a variety of ways and in a variety of settings. For example, the invention can be used to educate current and/or future fans about the rules and history a particular sport and possibly develop a lifelong fan.

Some terms are used throughout this specification. Definitions for these terms are provided below.

As used herein, the term “official” refers to a person who administers a game and enforces the rules during the game (i.e., a football game, a basketball game, a baseball game, a hockey game, a soccer game, a boxing match, a rugby match, etc.). Terms such as “referee”, “umpire”, “head linesman”, etc. are considered to be synonymous with the term official.

As used herein, the term “penalty” refers to a violation of a particular rule in a given sport. Terms such as “infraction”, “foul”, etc. are considered to be synonymous with the term penalty.

As used herein, the term “User” refers to a person viewing the displayed game content and/or interacting with the displayed game content as described in this invention. The score is representative of the performance of the User in the simulation.

As used herein, the term “personal computing device” refers to a computer or other device having a processor and memory capable of performing the method of the invention. The term personal computing devices such as computers, smartphones and tablets. The term encompasses various models made by manufactures such as Dell computer, Gateway computer, Apple, etc. The term also includes video game consoles such as the X-Box from Microsoft, the Playstation from Sony, PSP from Sony, the Gameboy system from Nintendo, etc. Another example of a suitable personal computing device is a television set having a set top box or TiVo.

As used herein, the term “displaying” has its conventional meaning and encompasses video, graphics, and/or audio content. Video content can be displayed on a medium such as a television screen, a computer screen, etc. Audio content can be displayed over a medium such as one or more speakers. Audio content can be displayed simultaneously with video content.

The term “showing” also has its conventional meaning.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

I claim:

1. A method for educating a sports fan comprising:
(a) displaying game content over a medium;
(b) showing one or more Messages;
(c) showing one or more Sports Interpretation Questions related to said Message(s);
(d) receiving and/or recording an Answer to the Sports Interpretation Question(s) in response to said Sports Interpretation Question(s);
(e) showing one or more Trivia Questions;
(f) receiving and/or recording an Answer to the Trivia Question(s) in response to said Trivia Question(s),
Wherein (a), (b), (c), (d), (e) and (f) occur as game content is displayed;
(g) repeating steps (a), (b), (c), (d), (e) and (f) until a set number of Sports Interpretation Questions and Trivia Questions are shown; and
(h) calculating a score based on the Answers received in response to one or more Sports Interpretation Questions and Trivia Questions.

2. A method for testing the knowledge of sports fans comprising
(a) displaying game content over a medium;
(b) showing one or more Messages;
(c) showing one or more Sports Interpretation Questions related to said Message(s);
(d) receiving and/or recording an Answer to the Sports Interpretation Question(s) in response to said Sports Interpretation Question(s);
(e) showing one or more Trivia Questions;
(f) receiving and/or recording an Answer to the Trivia Question(s) in response to said Trivia Question,
Wherein (a), (b), (c), (d), (e) and (f) occur as game content is displayed;
(g) repeating steps (a), (b), (c), (d), (e) and (f) until a set number of Sports Interpretation Questions and Trivia Questions are shown; and
(h) calculating a score based on the Answers received in response to one or more Sports Interpretation Questions and Trivia Questions.
